(19) United States
(12) Patent Application Publication
(10) Pub. No.: US 2014/0315168 A1
(43) Pub. Date: Oct. 23, 2014

(54) FACIAL EXPRESSION MEASUREMENT FOR ASSESSMENT, MONITORING, AND TREATMENT EVALUATION OF AFFECTIVE AND NEUROLOGICAL DISORDERS

(71) Applicant: Emotient, San Diego, CA (US)

(72) Inventors: Javier MOVELLAN, La Jolla, CA (US); Marian Steward BARTLETT, San Diego, CA (US); Ian FASEL, San Diego, CA (US); Gwen Ford LITTLEWORT, Solana Beach, CA (US); Joshua SUSSKIND, La Jolla, CA (US); Jacob WHITEHILL, Cambridge, MA (US)

(73) Assignee: Emotient, San Diego, CA (US)

(21) Appl. No.: 14/179,481

(22) Filed: Feb. 12, 2014

Related U.S. Application Data
(60) Provisional application No. 61/763,694, filed on Feb. 12, 2013.

(51) Int. Cl. G09B 19/00

(52) U.S. Cl. CPC G09B 19/00
USPC 434/236

(57) ABSTRACT

Apparatus, methods, and articles of manufacture facilitate diagnosis of affective mental and neurological disorders. Extended facial expression responses to various stimuli are evoked or spontaneously collected, and automatically evaluated using machine learning techniques and automatic facial expression measurement (AFEM) techniques. The stimuli may include pictures, videos, tasks of various emotion-eliciting paradigms, such as a reward-punishment paradigm, an anger eliciting paradigm, a fear eliciting paradigm, and a structured interview paradigm. The extended facial expression responses, which may include facial expression responses as well head pose responses and gesture responses, are analyzed using machine learning techniques to diagnose the subject, to estimate the likelihood that the subject suffers from a specific disorder, and/or to evaluate treatment efficacy.

### CROSS-REFERENCE TO RELATED APPLICATION

This application claims priority from U.S. provisional patent application Ser. No. 61/763,694, entitled AUTOMATIC FACIAL EXPRESSION MEASUREMENT AND MACHINE LEARNING FOR ASSESSMENT OF MENTAL ILLNESS AND EVALUATION OF TREATMENT, filed on Feb. 12, 2013, Atty Dkt Ref MPT-1014-PV, which is hereby incorporated by reference in its entirety as if fully set forth herein, including text, figures, claims, tables, and computer program listing appendices (if present), and all other matter in the United States provisional patent application.

### FIELD OF THE INVENTION

This document relates generally to apparatus, methods, and articles of manufacture for assessment, monitoring and treatment evaluation of affective and neurological disorders.

### BACKGROUND

Diagnosing affective and neurological disorders typically involves physical examinations, laboratory tests, and, most important, psychological evaluation. In the course of a psychological evaluation, a doctor or another mental health practitioner may talk to the patient about the patient's thoughts and feelings, behavioral patterns, and symptoms. Psychological evaluation may be quite time-consuming, expensive, and may not be available on a short notice. Many people are reluctant to see a mental health professional, and even when they do see one, it may take them many sessions to open up sufficiently for proper diagnosis. Moreover, affective and neurological disorder diagnosis is inherently subjective.

A need exists in the art to facilitate affective and neurological disorder diagnosis. Another need exists in the art to reduce the cost and time typically needed for diagnosing of affective and neurological disorders. Still another need exists in the art to inject a measure of objectivity in the diagnosis of affective and neurological disorders. Yet another need exists in the art for techniques for increasing the temporal resolution in monitoring, that is, more frequent monitoring of patients, such as on a daily rather than monthly basis.

### SUMMARY

Embodiments described in this document are directed to methods, apparatus, and articles of manufacture that may satisfy one or more of the above described and other needs.

In an embodiment, a computer-implemented method includes obtaining a first image comprising extended facial expression of a user responding to a first stimulus rendered through a user computing device, the first stimulus being evocative of a predetermined emotion or affective state; analyzing the first image with a machine learning classifier trained to differentiate between (1) features of extended facial expressions of the predetermined emotion or affective state in images of healthy subjects responding to stimuli evocative of the predetermined emotion or affective state, and (2) features of extended facial expressions of the predetermined emotion or affective state in images of subjects suffering from a predetermined disorder responding to the stimuli evocative of the predetermined emotion or affective state, thereby obtaining one or more analysis results; and using the one or more analysis results.

In an embodiment, a computing device includes at least one processor; machine-readable storage, the machine-readable storage being coupled to the at least one processor, the machine-readable storage storing instructions executable by the at least one processor; and means for allowing the at least one processor to obtain an image comprising extended facial expression of a user responding to a first stimulus evocative of a predetermined emotion or affective state. The instructions, when executed by the at least one processor, configure the at least one processor to analyze the first image with a machine learning classifier trained to differentiate between (1) features of extended facial expressions of the predetermined emotion or affective state in images of healthy subjects responding to stimuli evocative of the predetermined emotion or affective state, and (2) features of extended facial expressions of the predetermined emotion or affective state in images of subjects suffering from a predetermined disorder responding to the stimuli evocative of the predetermined emotion or affective state, thereby obtaining one or more analysis results, the one or more analysis results comprising an indication of whether the user suffers from the predetermined disorder.

The computing device may be or include a user device, such as a personal computer, a tablet, a smartphone, a wearable device such as Google Glass, in which case the means for allowing the at least one processor to cause the at least one stimulus to be rendered to the user may include a display of the user device, and the means for allowing the at least one processor to obtain an image may include a camera if the user device.

The computing device may also be a server-type computer, in which case the two means may include a network interface for coupling the computing device to a user device, and causing the user device to display the stimulus to the user, and to capture the user's extended facial expressions evoked by the stimulus.

The computing device may also render the first stimulus to the user.

In an embodiment, an article of manufacture includes one or more machine-readable memory devices storing computer code to configure at least one processor to: cause a first stimulus to be rendered to a user through a user computing device, wherein the first stimulus is evocative of a predetermined emotion or affective state; obtain a first image comprising extended facial expression of the user responding to the first stimulus rendered through the user computing device; analyze the first image with a machine learning classifier trained to differentiate between (1) features of extended facial expressions of the predetermined emotion or affective state in images of healthy subjects responding to stimuli evocative of the predetermined emotion or affective state, and (2) features of extended facial expressions of the predetermined emotion or affective state in images of subjects suffering from a predetermined disorder responding to the stimuli evocative of the predetermined emotion or affective state, thereby obtaining one or more analysis results; and use the one or more analysis results.

These and other features and aspects of the present invention will be better understood with reference to the following description, drawings, and appended claims.

### BRIEF DESCRIPTION OF THE FIGURES

FIG. 1 is a simplified block diagram representation of a computer-based system configured in accordance with selected aspects of the present description; and

FIG. 2 illustrates selected steps of a process for evoking responses to sensory stimuli, receiving facial expressions evoked by the stimuli, analyzing the facial expressions to evaluate the responses to the stimuli, and storing, transmitting, displaying, and/or otherwise using the results of the evaluations.

### DETAILED DESCRIPTION

In this document, the words “embodiment,” “variant,” “example,” and similar expressions refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar expressions and phrases may be used to indicate one of a number of different possible embodiments. The number of possible embodiments/variants/examples is not necessarily limited to two or any other quantity. Characterization of an item as “exemplary” means that the item is used as an example. Such characterization of an embodiment/variant/example does not necessarily mean that the embodiment/variant/example is a preferred one; the embodiment/variant/example may but need not be a currently preferred one.

All embodiments/variants/examples are described for illustration purposes and are not necessarily strictly limiting.

The words “couple,” “connect,” and similar expressions with their inflectional morphemes do not necessarily import an immediate or direct connection, but include within their meaning connections through mediate elements.

“Affective” information associated with an image or video includes various types of psychological reactions, such as affective (as this term is generally understood), cognitive, physiological, and/or behavioral responses, including both recorded raw signals and their interpretations. Relevant information that represents or describes a particular person's reaction(s) toward a stimulus in terms of the person's affective (as this term is generally understood), cognitive, physiological, or behavioral responses is referred to in the present description as affective information. The affective information can be attributable to psychological and physiological reactions such as memories, associations, and the like.

“Affective disorder” includes within its meaning mental disorders and neurological disorders, such as depression, bipolar disorders, autism, anxiety disorders, Parkinson's disease, and schizophrenia.

In the context of emotion eliciting paradigms, a “task” here means that a person is directed to perform, to do something, generally using a computing device. The computing device may be a mobile device (a smartphone, a tablet, a wearable device, such as Google Glass).

“Stimulus” and its plural form “stimuli” refer to actions, agents, or conditions that elicit or accelerate a physiological or psychological activity or response, such as an emotional response. Specifically, stimuli discussed in this document include still pictures and video clips. Stimuli also include tasks of the emotion eliciting paradigms.

“Causing to be displayed” and analogous expressions refer to taking one or more actions that result in displaying. A computer or a mobile device (such as a smart phone, tablet, Google Glass and other wearable devices), under control of program code, may cause to be displayed a picture and/or text, for example, to the user of the computer. Additionally, a server computer under control of program code may cause a web page or other information to be displayed by making the web page or other information available for access by a client computer or mobile device, over a network, such as the Internet, which web page the client computer or mobile device may then display to a user of the computer or the mobile device.

“Causing to be rendered” and analogous expressions refer to taking one or more actions that result in displaying and/or creating and emitting sounds. These expressions include within their meaning the expression “causing to be displayed,” as defined above. Additionally, the expressions include within their meaning causing emission of sound.

The word “image” refers to still images, videos, and both still images and videos. A “picture” is a still image. “Video” refers to motion graphics.

“Facial expression” as used in this document signifies the facial expressions of primary emotion (such as Anger, Contempt, Disgust, Fear, Happiness, Sadness, Surprise, Neutral); expressions of affective state of interest (such as boredom, interest, engagement); so-called “action units” (movements of a subset of facial muscles, including movement of individual muscles); changes in low level features (e.g., Gabor wavelets, integral image features, Haar wavelets, local binary patterns (LBP), Scale-Invariant Feature Transform (SIFT) features, histograms of gradients (HOG), Histograms of flow fields (HOFF), and spatio-temporal texture features such as spatiotemporal Gabors, and spatiotemporal variants of LBP such as LBP-TOP); and other concepts commonly understood as falling within the lay understanding of the term.

“Extended facial expression” means “facial expression” (as defined above), head pose, and/or gesture.

“Mental state” as used in this document means emotion, affective state, or similar psychological state; “expression of emotion, affective state, and similar psychological state” means expression of emotion, affective state, or similar psychological state.

Other and further explicit and implicit definitions and clarifications of definitions may be found throughout this document.

Reference will be made in detail to several embodiments that are illustrated in the accompanying drawings. Same reference numerals may be used in the drawings and the description to refer to the same apparatus elements and method steps. The drawings are in a simplified form, not to scale, and omit apparatus elements, method steps, and other features that can be added to the described systems and methods, while possibly including certain optional elements and steps.

Entire human brain systems are dedicated to recognition, classification, differentiation, and response to extended facial expressions. Disorders of these systems and other brain and nervous systems may be diagnosed with the help of assessment of extended facial expression responses to various stimuli. Additionally, the efficacy of various treatments of such disorders may be assessed by comparing a patient's before-treatment and after-treatment responses to various stimuli. Described herein are techniques for facilitating diagnosis of disorders and assessing efficacy of treatments of the disorders, based on automated extended facial expression analysis.

Automated facial expression measurement (“AFEM”) techniques can be used for relatively accurate and discriminative quantification of emotions in the healthy population, versus those of patient populations with affective and neurological disorders. AFEM techniques provide tools for clinical evaluations, as well as tools for objective quantification of the response to treatment. These tools can be used to assess the efficacy of both new and existing treatments, such as drugs.

In selected embodiments, models that describe the ways in which extended facial expression responses of patients with affective and neurological disorders differ from those of the mentally healthy population are constructed using AFEM and machine learning, and then employed for diagnostic and treatment assessment purposes. The mental illness or disorder models may include different models for affective and neurological disorders, such as depression, anxiety, manias, bipolar disorder (generally, depression alternating with mania); for neurological diseases such as Parkinsonism, schizophrenia, and psychoses in general. For example, extended facial expression responses of high-trait anxious subjects tend to be exaggerated for stimuli that elicit negative emotions, and extended facial expression responses of subjects with depression tend to be blunted for stimuli that elicit positive emotions. Here, machine learning methods are employed to develop models of how extended facial expressions, as measured by automatic methods (AFEM techniques), differ between (1) healthy subjects and (2) populations of patients suffering from a predetermined disorder. (The word “disorder” in this document signifies the mental and psychiatric disorders/illnesses, and neurological disorders mentioned above.)

For a model of a specific disorder, extended facial expression measurements of two populations may be obtained. Subjects of one population will have received a diagnosis of the specific disorder for which the model is constructed, and subjects of the second population will be a reference population of healthy human subjects, that is, subjects that do not suffer from the specific disorder. The same healthy subjects and their extended facial expressions may be used for models of different disorders. For the purpose of providing context, we may consider two specific mental illnesses: (1) depression, and (2) anxiety disorder; but by using this example (or any other example) we do not necessarily intend to limit the application of general principles described in this document.

Anxiety disorders include of a number of subtypes, but they generally focus on excessive irrational fear and dread. These include panic disorder, obsessive-compulsive disorder, post-traumatic stress disorder, social anxiety disorder, generalized anxiety disorder, and specific phobias. In embodiments, the same disorder model is used for all or some subset of two or more of the types of affective disorder. In other embodiments, the model used is specific to the specific disorder. In embodiments, the same anxiety disorder model is used for all or some subset of two or more of the types of anxiety disorder. In other embodiments, the model used is specific to the subtype of the anxiety disorder.

Ground truth data on disorder severity of each subject may be employed for construction of the models. Ground truth may include objective and subjective measures of a disorder, such as categorical information from psychiatric diagnosis, continuous (non-categorical) measures derived from self-rating scales, and objective rating scales provided by a clinician. A clinician may be a medical doctor (e.g., a psychiatrist), psychologist, therapist, or another type of mental health practitioner. The rating scales may include objective data such as weight loss and sleep patterns. Ground truth may be derived from self-reports; behavioral responses; involuntary physiological responses (such as heart rate, heart rate variability, breathing rate, pupil dilation, blushing, imaging data from MRI and/or functional MRI of the entire brain or portions of the brain such as amygdala); and third-party evaluations such as evaluations by clinicians and other trained personnel.

For depression, these scales may include (but are not limited to) the Beck Depression Inventory (BDI), the Hamilton Rating Scale, Montgomery-Asberg Depression Rating Scale (MADRS), the Zung Self-Rating Depression Scale, the Wechsler Depression Rating Scale, the Raskin Depression Rating Scale, the Inventory of Depressive Symptomatology (IDS), and the Quick Inventory of Depressive Symptomatology (QIDS). For anxiety, these scales may include (but are not limited to) the Stait Trait Anxiety Inventory (STAI), the Hamilton Anxiety Rating scale, the Panic Disorder Severity Scale, the Fear of Negative Evaluation Scale, the Post Traumatic Stress Disorder (PTSD) scale, the Yale Brown Obsessive Compulsive Scale, and the Dimensional Obsessive Compulsive scale.

Subjects may be presented with emotion eliciting paradigms, for example, presentation of an emotion eliciting stimulus. Such emotion eliciting stimuli may include (but are not limited to) pictures of spiders, snakes, comics, and cartoons; and pictures from the International Affective Picture set (IAPS). IAPS is described in Lang et al., The International Affective Picture System (University of Florida, Centre for Research in Psychophysiology, 1988), which publication is hereby incorporated by reference in its entirety. The emotion eliciting stimuli may also include film clips, such as clips of spiders/snakes/comedies; and the normed set from Gross & Levenson, Emotion Elicitation Using Films, Cognition and Emotion, 9, 87-108 (1995), which publication is hereby incorporated by reference in its entirety. Stimuli may also include a startle probe, which may be given in conjunction with emotion eliciting paradigms, or separately. Stimuli may also include neutral (baseline) stimuli.

Another example of emotion eliciting paradigms is a reward-punishment paradigm. For example, a set (one or more) of trials is presented a subject. On a particular trial, the subject is instructed to guess whether the number presented to the subject in the near future (such as on the immediately following screen) is higher or lower than a predetermined threshold number. The threshold number may be 5, and the presented numbers may lie between 1 and 9. If the subject guesses correctly, the subject gets a monetary or other reward; if the subject guesses incorrectly, the subject loses some money, or is otherwise made to suffer a “punishment.” An analogous trial involves hypothetical money or “points,” which may be good for some purpose, or simply be a means of keeping score. On each trial, there is a moment when the subject realizes that he or she got “rewarded” or “punished,” to some degree. Depressed patients will typically exhibit a reduced response to reward/win, and an exaggerated response to punishment/loss, relative to a non-depressed or healthy population without depression and/or other disorders. The extended facial expression responses of the subject may be recorded, summarized in a statistical manner, and/or otherwise analyzed.

It should be noted that the presentation of the stimulus, of whatever paradigm or nature, is not necessarily a requirement in any of the embodiments described in this document.

The degree of risk may vary from subject to subject, and from trial to trial involving the same subject, and it may be selectable by the subject and/or a clinician; the degree of risk selected by the subject for himself or herself may be part of the ground truth, and may be indicative of a particular disorder. People with depression, for example, tend to be more risk averse than healthy people; people with a mania tend to be more risk accepting.

Still other examples of emotion eliciting paradigms include an anger eliciting paradigm, and a fear eliciting paradigm. To elicit anger from a subject, the subject may be presented with a form to fill out. After the subject fills out the form, the subject may be informed that some field was incorrectly answered or was omitted. When the subject returns to remedy this purported deficiency, all or some of the fields may be deleted so that the subject needs to start over and consequently may be expected to become annoyed and angry. (The subject may not be aware that this is part of the paradigm, i.e., that the information in the fields is deleted intentionally to elicit an emotion.) Depressed people, however, may blame themselves, becoming less angry than healthy subjects.

Another paradigm is a structural interview. The subject may be asked questions, such as about plans for the future, and the automated extended facial expression recognition system may look for specific things, such as a lack of brow movement (which indicates non-engagement), a lack of action or reduced action of crow's feet muscles (the smiling with the eyes muscles), less smiling with the eyes, more contempt, more disgust, reduced joy, increased sadness and negativity, contempt, disgust, mouth smile. Those are the kind of responses that can be expected to present more often in depressed subjects than in non-depressed subjects. Here and elsewhere, the automated (machine-learned) expression classifier/recognizer may recognize the expressions using the Computer Expression Recognition Toolbox (CERT) and/or FACET technology for automated expression recognition. CERT was developed at the machine perception laboratory of the University of California, San Diego; FACET was developed by Emotient, the assignee of this application.

A number of tasks for eliciting fear may be employed as stimuli. In one, a subject is instructed to follow a maze on a screen with a mouse; the subject needs to focus on the screen to stay within the boundaries of the maze, highly focused. Close to the completion, when the subject is not expecting anything unusual, and suddenly, a loud sound and a zombie face are caused to be rendered. This tends to startle the subject and evoke a strong fear response.

Subjects suffering from schizophrenia, manias, and possibly other disorders may have different responses to fear. In particular, subjects suffering from schizophrenia and manias tend to exhibit increased reactivity (animation, uninhibitedness, as reflected in their intensity variability dynamics) to fear and anger, particularly in the lower face, and head pose (both static and dynamic), as compared to the healthy population. These features may advantageously be used to detect these disorders (schizophrenia in particular) automatically, through automatic examination of the extended facial expression responses elicited by the emotion eliciting paradigms and/or other stimuli.

The presentation of the emotion eliciting paradigms (reward-punishment, anger, fear, structured interview, similar paradigms), the recordation of the extended facial expression responses of the subject elicited in these paradigms, and the subsequent analysis of the responses, may be automated using one or more computers. As will be discussed below, all or some of the steps may be performed by one computer, such as a personal or other computer, or a mobile computing device, either autonomously or in conjunction with a remote computer system connected through a network.

The extended facial expression responses of the subjects may be recorded, for example, video recorded or recorded as one or more still pictures, and the expressions may then be measured by AFEM. The collection of the measurements may be considered to be a vector of extended facial expression responses. The vector (a one dimensional array of elements in a predetermined order) may include a set of displacements of feature points, motion flow fields, facial action intensities from the Facial Action Coding System (FACS), and/or responses of a set of automatic expression detectors or classifiers. Probability distributions for one or more extended facial expression responses for the patient population and the healthy population may be calculated for one or more of the stimuli or one or more types of stimuli, and the parameters (e.g., mean, variance, and/or skew) of the distributions computed.

Machine learning techniques and statistical models may be employed to characterize the relationships between facial responses from AFEM and ground truth measures for a particular disorder (e.g., anxiety ratings, depression ratings, etc.). Machine learning methods include but are not limited to support vector machines (SVMs), Adaboost, Gentleboost, relevance vector machines, and regression methods that include logistic regression and multinomial logistic regression. Once these relationships are learned based on sample populations with the disorders and a healthy population, the models can then predict depression ratings, anxiety ratings, or ratings of other disorders, for new subjects for whom ground truth is not yet available.

Direct training is another approach to machine learning of extended facial expression response differences between the healthy population and patient populations. The direct training approach works as follows. Videos of subjects with a specific disorder and videos of healthy subjects (without a specific disorder or any disorder) are collected, as is described above. Ground truths are also collected, as described above. Here, however, machine learning may be applied directly to the low-level image descriptors (instead of extracting facial expression measurements). The image descriptors may include (but are not limited to) Gabor wavelets, integral image features, Haar wavelets, local binary patterns (LBP), SIFT features, histograms of gradients (HOG), Histograms of flow fields (HOFF), and spatio-temporal texture features such as spatiotemporal Gabors, and spatiotemporal variants of LBP such as LBP on three orthogonal planes (LBP-TOP). These image features are then passed to a classifier trained with machine learning techniques to discriminate the patient group from the healthy group. Machine learning techniques used here include support vector machines (SVM), boosted classifiers such as Adaboost and Gentleboost, and action classification approaches from the computer vision literature, such as Bags of Words models.

The Bags of Words is a computer vision approach known in the text recognition literature, which involves clustering the training data, and then “histogramming” the occurrences of the clusters for a given example. The histograms are then passed to standard classifiers such as SVM. The Bags of Words model is described in Sikka et al., Exploring Bag of Words Architectures in the Facial Expression Domain (UCSD 2012) (available at http://mplab.ucsd.edu/˜marni/pubs/Sikka_LNCS_{—}2012.pdf).

After training, the classifier may provide information about new, unlabeled data, such as the likelihood ratio that the new subject is from the healthy population versus patient population with a particular disorder. Boosted classifiers such as Adaboost provide an estimate of this likelihood ratio. For SVMs, a measure of the likelihood may be provided by the distance to the separating hyperplane, called “the margin.”

The patient and healthy models and their comparisons are not limited to static variables. The dynamics of facial behavior (and, more generally, of extended facial expression responses) in the patient and healthy subjects may also be characterized, and the differences in the respective dynamic behaviors may also be modeled and used in subsequent assessments. Parameters may include onset latencies, peaks of deviations in facial measurement of predetermined facial points or facial parameters, durations of movements of predetermined facial points or facial parameters, accelerations (rates of change in the movements of predetermined facial points or facial parameters), overall correlations (e.g., correlations in the movements of predetermined facial points or facial parameters), and the differences between the areas under the curves plotting the movements of predetermined facial points or facial parameters. The full distributions of response trajectories may be characterized through dynamical models such as hidden Markov Models (HMMs), Kalman filters, diffusion networks, and/or others. The dynamical models may be trained directly on the sequences of low-level image features, or on sequences of AFEM outputs. Separate models may be trained for each patient population (that is, for the patient population with the specific disorder) and for the healthy population (population without the specific disorder or without any known disorder). After training, the models as applied by the trained machine learning classifier, may provide a measure of the likelihood that the subjects' extended facial expression data came from the healthy population or from a population with the specific disorder; that is, the classifier may provide some indication (e.g., a probability or another estimate) of whether a particular subject has the disorder or does not have the disorder.

As has already been mentioned, the diagnostic techniques based on the extended facial expression responses to emotion eliciting paradigms (and/or startle) may be extended to assessment of efficacy of various treatments. Multiple sets of stimuli are defined so that the patient-subject may be presented with a different stimulus each time. The stimuli sets may be counter-balanced, in order to remove the effects of stimulus differences and the differences in the order of presentation of stimuli due to the patients or healthy subjects becoming inured to the stimuli.

Extended facial expression responses post-treatment may be compared to extended facial expression responses pre-treatment, to assess the degree to which the responses have become more similar to those of healthy subjects. Standard pattern similarity measures from the pattern recognition literature may be employed to assess response similarity. These measures include (but are not limited to) distance measures (Euclidean distance, Mahalanobis distance, L1) to the healthy probability distribution, template matching methods, and angles between the pattern vectors. Improvement may be measured as the increase in similarity of the extended facial expression response vector to that of the healthy population. The comparison of pre- and post-treatment extended facial expression responses to stimuli may be performed on statistical measures of aggregated responses of a plurality of patients, for example, to assess the efficacy of a certain treatment (e.g., a new experimental drug or treatment) in general. The comparison of pre- and post-treatment extended facial responses to stimuli may also be performed for a given patient, to assess the efficacy of the treatment for that particular patient. Similarly, the statistical and individual comparisons may be performed for a population of healthy subjects, for investigation or other purposes.

Improvement may also be measured by changes in the likelihood that the extended facial expression response came from the healthy population, compared to each patient population. Likelihood ratios may be computed or estimated. These are ratios of the likelihood of the patient class relative to the healthy class, given the observed facial data (or extended facial data, which includes the facial data and data describing head poses and gestures). An increase in the likelihood that the extended facial data came from the healthy population may be considered to be a measure of improvement due to the treatment and/or other factors.

Post-treatment responses may be measured multiple times following treatment(s). Post-treatment responses may also be measured for multiple dose levels of pharmaceutical agents and for multiple intensities of other treatments.

The monitoring of the patient's responses may be continual and frequent. For example, rather than visiting a psychiatry once a month or once a week, daily or even hourly data about the affective state of the patient may be obtained.

In embodiments, the automated system for comparing facial expression responses to stimuli may be implemented using a user device, functioning either autonomously or in conjunction with a remote server to which the user device is coupled through a network. The user device may be, for example, a laptop or a desktop computer, a smartphone, a tablet, a wearable device such as Google Glass, or another portable or stationary device. User devices, and especially mobile devices, may enable more frequent patient assessments than office visits.

The user device can take expression measures, for example, daily, or at multiple time points during each day; the times of the assessments may be preset or randomized, or both. The times may be set by the user of the device, a health practitioner or clinician, or otherwise. Probes may be presented to the patient through the user device, such as an emotion eliciting stimulus, which may include a question, an instruction, such as “think about your plans for today,” a sound, an image. The user device may also take expression measures during spontaneous behavior, for example, extended facial expressions while the user is driving or doing work on a laptop, smartphone, or another device. Extended facial expression responses may be determined by taking images (pictures/videos) through the portable device's camera, and evaluating the pictures/videos as is described above, using, for example, AFEM techniques. Reports and summaries of assessments may be automatically generated and sent to a physician or another clinician or care provider. This method has an additional advantage that the identity of the patient evaluated remotely can be verified because of the availability of the pictures or videos of the patient's face.

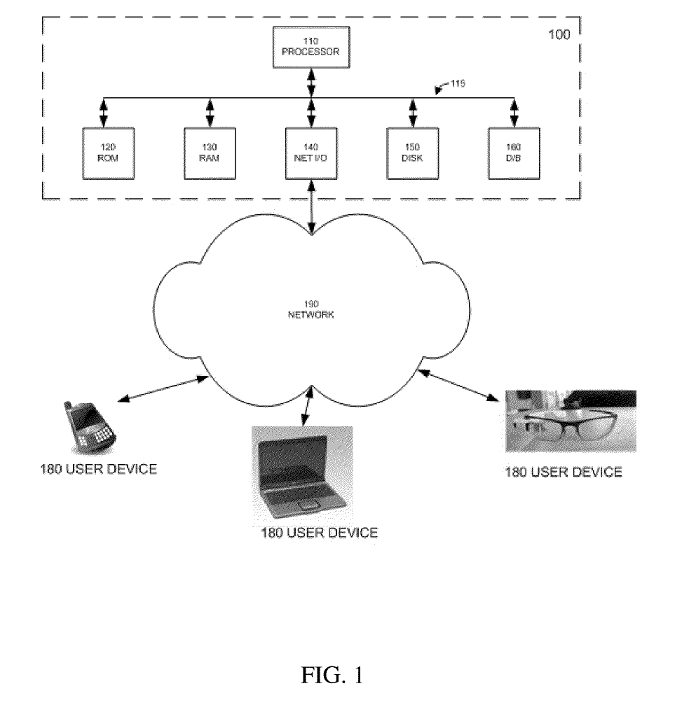

FIG. 1 is a simplified block diagram representation of a computer-based system 100 and portable user devices 180, configured for patient assessment through the user devices, in accordance with selected aspects of the present description. The system 100 may interact through a communication network 190 with users at the user devices 180, such as personal computers and mobile devices (e.g., PCs, tablets, smartphones, wearable devices such as Google Glass). The system 100 may be configured to perform steps of methods (such as the method 200 described in more detail below) for evoking user responses to stimuli presented through the user devices 180, receiving the extended facial expressions of the users, analyzing the extended facial expression responses to evaluate the users' mental, neurological, or other conditions/disorders, and storing/transmitting/displaying or otherwise using the results of the evaluations. In embodiments, the analysis and/or other steps may be performed by a user device 180, autonomously or semi-autonomously, and then the results may be transmitted through the network 190 to the system 100 or to another computer system.

FIG. 1 does not show many hardware and software modules of the system 100 and of the user devices 180, and omits various physical and logical connections. The system 100 may be implemented as a special purpose data processor, a general-purpose computer, a computer system, or a group of networked computers or computer systems configured to perform the steps of the methods described in this document. In some embodiments, the system 100 is built using one or more of cloud devices, smart mobile devices, wearable devices. In some embodiments, the system 100 is implemented as a plurality of computers interconnected by a network, such as the network 190, or another network.

As shown in FIG. 1, the system 100 includes a processor 110, read only memory (ROM) module 120, random access memory (RAM) module 130, network interface 140, a mass storage device 150, and a database 160. These components are coupled together by a bus 115. In the illustrated embodiment, the processor 110 may be a microprocessor, and the mass storage device 150 may be a magnetic disk drive. The mass storage device 150 and each of the memory modules 120 and 130 are connected to the processor 110 to allow the processor 110 to write data into and read data from these storage and memory devices. The network interface 140 couples the processor 110 to the network 190, for example, the Internet. The nature of the network 190 and of the devices that may be interposed between the system 100 and the network 190 determine the kind of network interface 140 used in the system 100. In some embodiments, for example, the network interface 140 is an Ethernet interface that connects the system 100 to a local area network, which, in turn, connects to the Internet. The network 190 may therefore be a combination of several networks.

The database 160 may be used for organizing and storing data that may be needed or desired in performing the method steps described in this document. The database 160 may be a physically separate system coupled to the processor 110. In alternative embodiments, the processor 110 and the mass storage device 150 may be configured to perform the functions of the database 160.

The processor 110 may read and execute program code instructions stored in the ROM module 120, the RAM module 130, and/or the storage device 150. Under control of the program code, the processor 110 may configure the system 100 to perform the steps of the methods described or mentioned in this document. In addition to the ROM/RAM modules 120/130 and the storage device 150, the program code instructions may be stored in other machine-readable storage media, such as additional hard drives, floppy diskettes, CD-ROMs, DVDs, Flash memories, and similar devices. The program code may also be transmitted over a transmission medium, for example, over electrical wiring or cabling, through optical fiber, wirelessly, or by any other form of physical transmission. The transmission can take place over a dedicated link between telecommunication devices, or through a wide area or a local area network, such as the Internet, an intranet, extranet, or any other kind of public or private network. The program code may also be downloaded into the system 100 through the network interface 140 or another network interface.

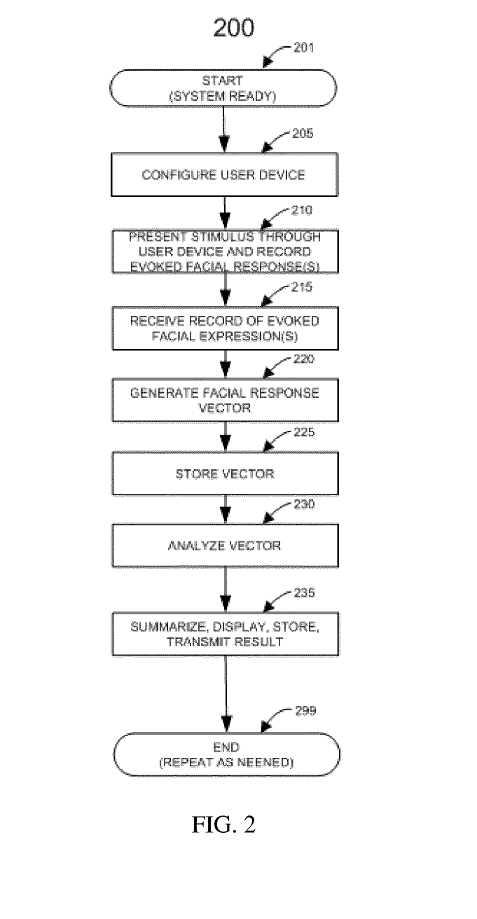

FIG. 2 illustrates selected steps of a process 200 for evoking user responses to sensory stimuli; receiving extended facial expressions of the users; analyzing the extended facial expressions to evaluate the users' responses to the stimuli; and storing, transmitting, displaying, and/or otherwise using the results of the analyses or evaluations. The method may be performed, for example, by the system 100 in combination with a user device 180. Analogous methods may be performed, for example, by the user devices 180, by a combination of the system 100 and user devices 180, or by other distributed or localized computer-based systems.

At flow point 201, the system 100 and a user device 180 of one of the users are powered up, connected to the network 190, and otherwise ready to perform the following steps.

In step 205, the system 100 communicates with the user device 180, and configures the user device 180 to present some preselected stimulus or stimuli to the user and simultaneously to record extended facial expressions of the user evoked by the stimulus or stimuli. As discussed above, the stimulus or stimuli may be or include an image or video of spiders, snakes, comedies, IAPS pictures, film clips such as those of the normed set of Gross & Levenson, various sounds, tasks of emotion eliciting paradigms, and still other stimuli. The presented stimulus or stimuli may be designed to evoke a strong psychological reaction in healthy subjects and/or in subjects with some disorders.

In step 210, the system 100 causes the user device 180 to present to the user at the user device the stimulus/stimuli from the step 205, and to record the user's extended facial expression(s) evoked by the stimulus/stimuli.

In step 215, the system 100 obtains the record of the user's extended facial expressions recorded by the user device in the step 210. In embodiments, the system 100 obtains the user's extended facial expressions, substantially in real time. In other embodiments, the system 100 obtains the record of facial expressions of the user at a later time.

In step 220, the system 100 (and/or the user device 180) measures the extended facial response(s) evoked in the user by the stimulus or stimuli, using, for example, AFEM, and generating a vector of extended facial response(s). In generating the vector, the system 100 may also (or instead) compute a set of displacements of feature points, motion flow fields, facial action intensities from the Facial Action Coding System (FACS), and/or responses of a set of automatic classifiers or detectors of extended facial expressions.

In step 225, the system 100 stores the vector from the step 220.

In step 230, the system 100 analyzes the vector, and in step 235, summarizes the result of the comparison test and displays, stores, and/or transmits it for the use of a physician, clinician, other mental health personnel, and/or the user. For example, the system 100 may compare the current vector to one or more previous vectors of the same user, to estimate progression or regression of a predetermined disorder, perhaps in response to some treatment administered to the user between the times corresponding to the two vectors. The system 100 may also compare the current vector to one or more previous vectors of the same user to determine whether significantly different disorders are manifested at different times. Note that manifestations of depression alternating over time with manifestations of a mania may indicate a bipolar disorder. The time differences may be, for example, in the order of minutes, hours, days, weeks, months, years. In specific variants, the process is performed daily.

As another example, the system 100 may compare the current vector (1) to the corresponding vector whose elements are statistics of the corresponding data of a healthy population and/or (2) the corresponding vector whose elements are statistics of the corresponding data of a population of subjects with a predetermined disorder; thereby obtaining a measure/estimate of the probability that the user suffers from the predetermined disorder. The system 100 may compute a first inner product of the user's vector with the vector of statistics from the healthy population, and a second inner product of the user's vector with the vector of statistics from the population with the predetermined disorder. An estimate of the probability may be based on the relative sizes of the two inner products. In embodiments, the ratio and/or the two inner products is/are displayed to a health practitioner, together with the statistics relating the ratio and/or the inner products to the probability of the user having the predetermined disorder, and the expected degree of the disorder in the user.

In embodiments, in the step 235 the system may generate an automated diagnosis or a preliminary diagnosis. The diagnosis may be determined by reference to a multi-dimensional mapping of the ratio and/or the two inner products and differential diagnoses (e.g., some values being mapped to “healthy” diagnosis, others to “depression” diagnoses. Based on the diagnosis, which may be performed without necessitating an office visit or another face-to-face interaction between the user and a medical practitioner, an actual office visit may be suggested and a referral provided. Also, a practitioner may review the data underlying the vector, possibly including the actual recording of the user's responses, and confirm the diagnosis, make another diagnosis, or otherwise act on the data provided.

At flow point 299, the process 200 may terminate, to be repeated as needed for the same user and/or other users.

The user device 180 may perform all or some of the steps autonomously, that is, without reliance on the system 100 and/or the communication network 190. Thus, in embodiments, the user device (1) presents the stimulus to the user at the device, (2) records the user's extended facial expression(s) evoked by the stimulus, (3) measures the extended facial response(s) using, for example, AFEM, and/or computing a set of displacements of feature points, motion flow fields, facial action intensities from the Facial Action Coding System (FACS), and/or responses of a set of automatic expression classifiers, thereby obtaining a vector corresponding to the expression evoked by the stimulus, (4) performs analysis of the vector, and (5) stores, transmits, and/or displays the result of the analysis.

The system and process features described throughout this document may be present individually, or in any combination or permutation, except where presence or absence of specific feature(s)/element(s)/limitation(s) is inherently required, explicitly indicated, or otherwise made clear from the context.

Although the process steps and decisions (if decision blocks are present) may be described serially in this document, certain steps and/or decisions may be performed by separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific embodiments/variants/examples use the particular order(s) in which the steps and decisions (if applicable) are shown and/or described.

The instructions (machine executable code) corresponding to the method steps of the embodiments, variants, and examples disclosed in this document may be embodied directly in hardware, in software, in firmware, or in combinations thereof. A software module may be stored in volatile memory, flash memory, Read Only Memory (ROM), Electrically Programmable ROM (EPROM), Electrically Erasable Programmable ROM (EEPROM), hard disk, a CD-ROM, a DVD-ROM, or other forms of non-transitory storage medium known in the art, whether volatile or non-volatile. Exemplary storage medium or media may be coupled to one or more processors so that the one or more processors can read information from, and write information to, the storage medium or media. In an alternative, the storage medium or media may be integral to one or more processors.

This document describes in considerable detail the inventive apparatus, methods, and articles of manufacture for assessing mental and neurological disorders, and evaluating treatments of such disorders, using automatic extended facial expression measurements. This was done for illustration purposes. The specific embodiments or their features do not necessarily limit the general principles underlying the invention. The specific features described herein may be used in some embodiments, but not in others, without departure from the spirit and scope of the invention as set forth herein. Various physical arrangements of components and various step sequences also fall within the intended scope of the invention. Many additional modifications are intended in the foregoing disclosure, and it will be appreciated by those of ordinary skill in the pertinent art that in some instances some features will be employed in the absence of a corresponding use of other features. The illustrative examples therefore do not necessarily define the metes and bounds of the invention and the legal protection afforded the invention, which function is carried out by the claims and their equivalents.

What is claimed is:

1. A computer-implemented method comprising steps of:
obtaining a first image comprising extended facial expression of a user responding to a first stimulus rendered through a user computing device, the first stimulus being evocative of a predetermined emotion or affective state;
analyzing the first image with a machine learning classifier trained to differentiate between (1) features of extended facial expressions of the predetermined emotion or affective state in images of healthy subjects responding to stimuli evocative of the predetermined emotion or affective state, and (2) features of extended facial expressions of the predetermined emotion or affective state in images of subjects suffering from a predetermined disorder responding to the stimuli evocative of the predetermined emotion or affective state, thereby obtaining one or more analysis results; and
using the one or more analysis results.

2. A computer-implemented method as in claim 1, further comprising:
causing the first stimulus to be rendered to the user through the user computing device;
wherein:
the step of using the one or more analysis results comprises a step selected from the group consisting of storing the one or more analysis results in a machine memory device, transmitting the one or more analysis results over a network, and causing the one or more analysis results to be rendered.

3. A computer-implemented method as in claim 2, wherein the one or more analysis results comprise an indication of whether the user suffers from the predetermined disorder.

4. A computer-implemented method as in claim 2, wherein the one or more analysis results comprise a quantification of likelihood of the user suffering from the predetermined disorder.

5. A computer-implemented method as in claim 2, wherein the step of using the one or more analysis results comprises causing the one or more analysis results to be displayed to the user.

6. A computer-implemented method as in claim 2, wherein the step of using the one or more analysis results comprises causing the one or more analysis results to be displayed to one or more medical personnel.

7. A computer-implemented method as in claim 2, wherein the step of analyzing is performed at a computing device communicating with the user device over a wide area network.

8. A computer-implemented method as in claim 2, wherein the steps of causing the stimulus to be rendered, obtaining the first image, and analyzing the first image are performed by the user device.

9. A computer-implemented method as in claim 8, wherein the user device is a mobile device.

10. A computer-implemented method as in claim 2, wherein the first stimulus comprises a stimulating image.

11. A computer-implemented method as in claim 2, wherein the first stimulus comprises a sound.

12. A computer-implemented method as in claim 2, wherein the first stimulus comprises a task from an emotion-eliciting paradigm.

13. A computer-implemented method as in claim 2, wherein the first stimulus comprises a task from a reward-punishment paradigm.

14. A computer-implemented method as in claim 2, wherein the first stimulus comprises a task selected from the group consisting of a fear-eliciting paradigm, an anger-eliciting paradigm, and a structured interview.

15. A computer implemented method as in claim 2, further comprising:
causing a second stimulus to be rendered to the user through the user computing device, wherein the second stimulus is evocative of the predetermined emotion or affective state; and
obtaining a second image comprising extended facial expression of the user responding to the second stimulus rendered through the user computing device;
wherein:
the step of analyzing the first image comprises analyzing the first image and the second image with the machine learning classifier, thereby obtaining the one or more analysis results associated with the first image and with the second image; and
the stimuli used in training the classifier include at least one of the first stimulus and the second stimulus.

16. A computer-implemented method of claim 2, wherein the step of analyzing comprises:
applying to the first image automated facial expression measurement (AFEM) to obtain discriminative quantification of emotions evoked by the first stimulus;
generating a facial response vector from the first image;
comparing the facial response vector from the first image with (1) a facial response vector based on statistics of a healthy population, and (2) a facial response vector based on statistics of a patient population suffering from the predetermined disorder.

17. A computing device comprising:
at least one processor;
machine-readable storage, the machine-readable storage being coupled to the at least one processor, the machine-readable storage storing instructions executable by the at least one processor; and
means for allowing the at least one processor to obtain an image comprising extended facial expression of a user responding to a first stimulus evocative of a predetermined emotion or affective state;
wherein:
the instructions, when executed by the at least one processor, configure the at least one processor to analyze the first image with a machine learning classifier trained to differentiate between (1) features of extended facial expressions of the predetermined emotion or affective state in images of healthy subjects responding to stimuli evocative of the predetermined emotion or affective state, and (2) features of extended facial expressions of the predetermined emotion or affective state in images of subjects suffering from a predetermined disorder responding to the stimuli evocative of the predetermined emotion or affective state, thereby obtaining one or more analysis results, the one or more analysis results comprising an indication of whether the user suffers from the predetermined disorder.

18. A computing device as in claim 17, wherein:
the machine-readable storage further stores data, the data comprising the first stimulus evocative of the predetermined emotion or affective state; and
the means for allowing the at least one processor to obtain the first image comprises a camera;
the computing device further comprising:
a display coupled to the at least one processor to allow the at least one processor to cause the at least one stimulus to be rendered to the user.

19. A computing device as in claim 17, further comprising:
a network interface coupling the computing device to a user device;
wherein:
the machine-readable storage further stores data, the data comprising the first stimulus evocative of the predetermined emotion or affective state; and
the means for allowing the at least one processor to obtain the first image comprises the network interface.

20. An article of manufacture comprising one or more machine-readable memory devices storing computer code to configure at least one processor to:
cause a first stimulus to be rendered to a user through a user computing device, wherein the first stimulus is evocative of a predetermined emotion or affective state;
obtain a first image comprising extended facial expression of the user responding to the first stimulus rendered through the user computing device;
analyze the first image with a machine learning classifier trained to differentiate between (1) features of extended facial expressions of the predetermined emotion or affective state in images of healthy subjects responding to stimuli evocative of the predetermined emotion or affective state, and (2) features of extended facial expressions of the predetermined emotion or affective state in images of subjects suffering from a predetermined disorder responding to the stimuli evocative of the predetermined emotion or affective state, thereby obtaining one or more analysis results; and
use the one or more analysis results.
